(19) United States
(12) Patent Application Publication
(10) Pub. No.: US 2015/0314864 A1
(43) Pub. Date: Nov. 5, 2015

(54) Overlapping Synchronized Twin Blades

(71) Applicant: Gyula Cserfoi, Vancouver, WA (US)

(72) Inventor: Gyula Cserfoi, Vancouver, WA (US)

(21) Appl. No.: 14/694,079

(22) Filed: Apr. 23, 2015

Related U.S. Application Data
(60) Provisional application No. 61/987,610, filed on May 2, 2014.

(51) Int. Cl. B64C 27/10

(52) U.S. Cl. CPC B64C 27/10

(57) ABSTRACT

Synchronized overlapping twin blades for use with a rotary-wing aircraft. The synchronization mechanism includes a housing. The housing comprises a first angled side and a second angled side. A first rotor is attached to the first angled side of the housing and a second rotor is attached to the second angled side of the housing. The first and second rotors are secured to the synchronizing mechanism via teeter bolts that enable the blades of the rotors to be positioned within the rotor disc area. The first and second rotors are disposed at an angle relative to one another such that the paths of the rotors are in overlapping positions. The synchronization mechanism utilizes a gear system to prevent the first rotor and the second rotor from striking while rotating in an overlapping path.

### CROSS REFERENCE TO RELATED APPLICATION

This application claims the benefit of U.S. Provisional Application No. 61/987,610 filed on May 2, 2014. The above identified provisional patent application is herein incorporated by reference in its entirety.

### FIELD OF THE INVENTION

The present invention relates to an apparatus for a twin blade system in a rotary aircraft, and more particularly to an apparatus for an overlapping synchronized twin blade system in a rotary aircraft.

### BACKGROUND OF THE INVENTION

Autogyros or gyrocopters are a type of rotory aircraft that use an unpowered rotor in order to develop lift, along with an engine-powered propeller that provides thrust. Air flows through the rotor disc to generate rotation of the rotor, and thus lift for the rotorcraft. An autogyro's rotor must have air flowing up and through the rotor disk in order to generate rotation. In order to control the direction of travel of the autogyro, the rotor must be tilted in the desired direction or a tail rotor must be provided.

Rotary-wing aircrafts, such as helicopters, have found many applications due to the vertical flight and hovering capabilities of such craft. These capabilities are achieved through the use of rotary wings that utilize rotor blades. Rotary wing aircrafts are capable of generating lift even in vertical flight or while hovering because the rotary motion causes airflow about the surfaces of the rotary wings. A disadvantage of conventional rotary wing aircraft, i.e., helicopters employing a single main rotor blade assembly in their principal lift generating system, is that such aircraft generally employ a heavy and power-consuming tail rotor for torque compensation and yaw control. Torque is exerted on conventional rotary wing aircraft due to the rotation of the main rotor blade assembly which would result in rotation of the aircraft body if not counteracted.

Typically, this torque is counteracted by use of a tail rotor which generates a torque equal but opposite to that of the main rotor blade assembly. The pitch of the tail rotor blades may also be adjustable to vary the torque generated by the tail rotor thereby providing helicopter yaw control. Thus, in conventional helicopters, a significant amount of power and weight is directed to the tail rotor for torque compensation and yaw control. This extra mechanism makes it far more difficult to fly and to land. This also makes the aircraft more unsafe, not only because it's harder to fly, but also because the tail rotor can strike someone.

Thus, it would be advantageous if the positive attributes of fixed wing and rotary wing aircraft could be combined. Desirably, such a rotary wing aircraft could combine the hovering and vertical flight capability of rotary wing aircraft with the efficiency and simplicity of fixed wing aircraft in forward flight.

Additionally, as with all aircrafts, the aim of gyrocopters is to have as light and compact a construction as possible. This is especially important with gyrocopters because, in order to be approved as a sport aircraft, the mass must not exceed 450 kg. Thus, the goal is to construct a particularly light weight aircraft that provides enough torque.

Therefore, it is desirable in many applications to have a twin blade rotary aircraft that can achieve all the movements of a conventional rotary aircraft with reduced mechanical complexity and weight. It is also desirable to have a rotary aircraft with an overlapping rotary system to achieve a relatively compact design. Additionally, it would be advantageous to have an overlapping rotary system that is synchronized to prevent rotary damage or rotorcraft malfunctions.

### SUMMARY OF THE INVENTION

In view of the foregoing disadvantages inherent in the known types of rotary aircrafts now present in the prior art, the present invention provides a synchronized twin blade rotary system with overlapping rotors. The synchronized overlapping twin blade system provides users with a more compact and efficient design for a rotary aircraft.

It is therefore an object of the present invention to provide new and improved synchronized overlapping rotors in a twin blade system that has all of the advantages of the prior art and none of the disadvantages.

Accordingly, one example of the present invention is an apparatus for synchronizing overlapping rotors in a twin blade system. The apparatus includes a synchronization mechanism comprising of a housing. The housing may have a first angled side and a second angled side. The apparatus further includes a first rotor attached to the first angled side of the housing and a second rotor attached to the second angled side of the housing. The first rotor and the second rotor have an overlapping rotor path. The first rotor and the second rotor are attached to the housing using a teeter bolt. The synchronization mechanism may utilize a gear system to prevent the first rotor and the second rotor from striking while rotating in an overlapping path.

In another example embodiment, the housing may be a triangular shape. The triangular shape of the housing allows the first rotor and second rotor to be at angle that promotes overlapping of the rotors. The overlapping rotors provides a compact design for a rotorcraft.

In another example embodiment of the present invention, the first rotor and the second rotor are configured to have an overlapping path. The syncing mechanism prevents the first rotor and the second rotor from striking while rotating in their respective disc areas.

It is another object of the present invention to provide a twin blade synchronizing mechanism that attaches the first and second rotors to the synching mechanism via a teeter bolt. The teeter bolt allows a pitch of the first rotor and the second rotor to be adjusted according to the desired specifications of the user. Additionally, the pitch of the rotors can be adjusted automatically as the rotorcraft moves naturally.

Another object of the present invention is to provide an assembly unit below the synchronization mechanism housing. The assembly unit may attach to the original control and support head of a rotorcraft. The assembly unit provides an easily detachable unit for rotorcraft assembly.

Other objects, features and advantages of the present invention will become apparent from the following detailed description taken in conjunction with the accompanying drawings.

### BRIEF DESCRIPTIONS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a perspective view of the twin rotor system according to one embodiment of the present invention.

FIG. 2 shows a side view of the twin rotor system according to one embodiment of the present invention.

FIG. 3 shows an overhead view of the twin rotor system according to one embodiment of the present invention.

FIG. 4 shows a front view of the twin rotor system according to one embodiment of the present invention.

FIG. 5 shows the gear mechanism in the housing of the synchronization mechanism according to one embodiment of the present invention.

### DETAILED DESCRIPTION OF THE INVENTION

Reference is made herein to the attached drawings. Like reference numerals are used throughout the drawings to depict like or similar elements of the synchronized overlapping twin blades. For the purposes of presenting a brief and clear description of the present invention, the preferred embodiment will be discussed as used for synchronized overlapping twin blades. The figures are intended for representative purposes only and should not be considered to be limiting in any respect.

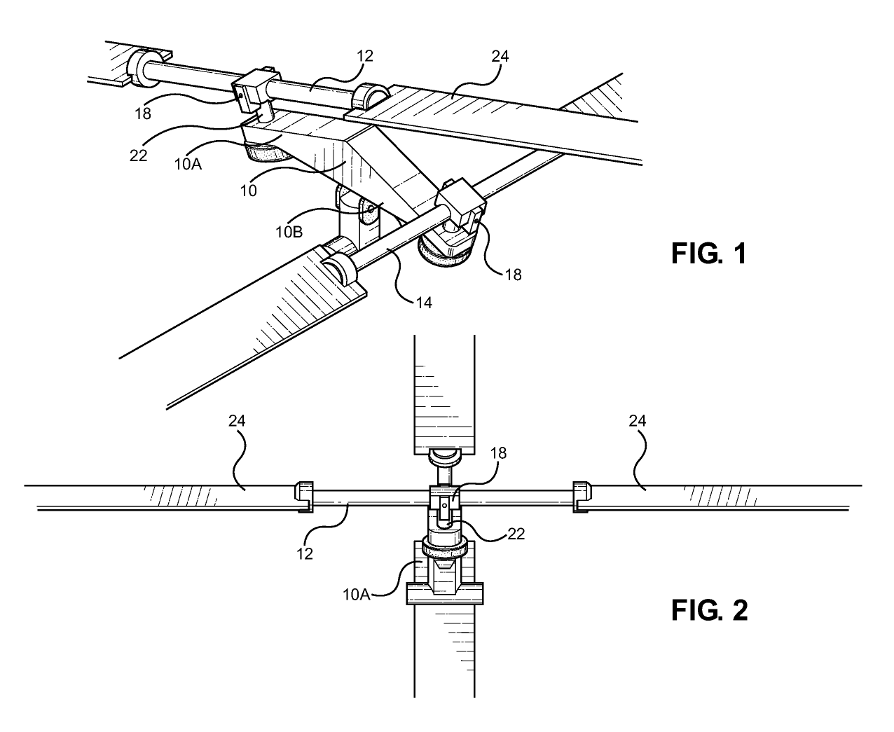

FIG. 1 shows a perspective view of the synchronized overlapping twin rotor system according to one embodiment of the present invention. The apparatus for synching rotors in a twin blade rotary aircraft may comprise a housing 10, a first angled side 10A of the housing, a second angled side 10B of the housing, a first rotor 12 attached to the first angled side 10A of the housing 10, a second rotor 14 attached to the second angled side 10B of the housing 10. The present invention may further comprise a teeter bolt 18 that attaches the first rotor 12 and the second rotor 12 to the first angled side 10A of the housing 10 and the second angled side 10B of the housing 10, respectively.

In another example embodiment, the present invention may relate to an improvement in the rotor system for autogyros, or gyrocopters. The improved rotor system includes an angled synchronizing mechanism comprising a housing 10 having a first angled side 10A and a second angled side 10B. The housing 10 has a substantially triangular shape such that the first and second sides are sloped, and are disposed at an angle. A first rotor 12 is attached to the first angled side 10A of the synchronizing mechanism by a teeter bolt 18. Similarly, a second rotor 14 is attached to the second angled side 10B of the synchronizing mechanism by a teeter bolt 18. The first angled side 10A and the second angled side 10B are configured to have a slope that allows the first rotor path and the second rotor path to overlap during operation of the autogyro or gyrocopter.

FIG. 2 shows a right side view of the twin rotor system according to one embodiment of the present invention. The first rotor 12 comprises a pair of blades 24 that are adapted to rotate about a central shaft 22 that is attached to the housing by a teeter bolt 18. Similarly, the second rotor comprises a pair of blades 24 that are adapted to rotate about a central shaft 22 that is attached to housing by a teeter bolt 18. The rotors are adapted to rotate as result of airflow through the rotors in order to provide lift. Each rotor is disposed at an angle as result of the sloped sides of the housing 10A. The teeter bolts 18 allow the pitch of the rotors to be adjusted as a gyro naturally travels.

The synchronizing mechanism is angled to provide an overlapping path for the twin rotor system. The overlapping path provides a compact configuration where the first rotor and the second rotor can be placed close together. The rotors may comprise a pair of blades that are adapted to rotate about a central shaft. The synchronization mechanism utilizes a gear system to prevent the first rotor and the second rotor from striking while rotating in an overlapping path.

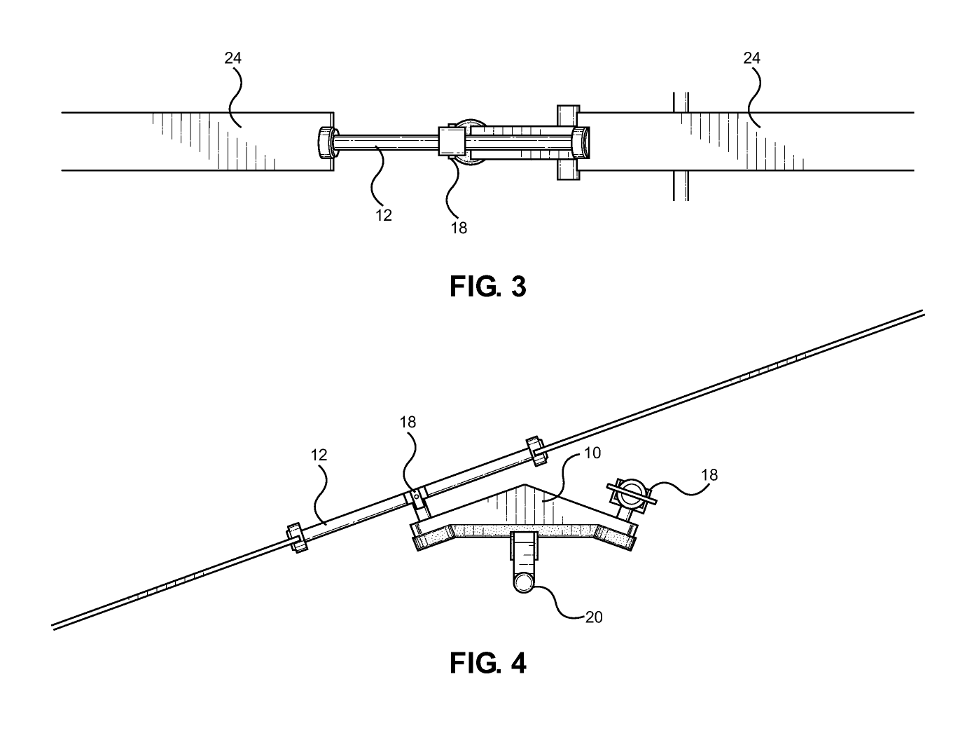

FIG. 3 shows an overhead view of the twin rotor system according to one embodiment of the present invention. The rotor 12 comprises a pair of blades 24. The blades 24 that are adapted to rotate about a central shaft 22 that is attached to housing by a teeter bolt 18. The teeter bolt 18 may be configured to allow a pitch of the first 12 rotor and the second rotor 14 to be adjusted.

The first rotor 12 and the second rotor 14 are positioned such that a portion of the path of the rotors overlaps. In this way, first rotor 12 and the second rotor 14 can be placed close together, so as to maintain a relatively compact configuration. The synchronizing mechanism prevents the rotors from striking one another as the rotors spin. Thus, the present invention provides a user with increased control over the operation of an autogyro.

Referring now to FIG. 4, there is shown a front view of the twin rotor system according to one embodiment of the present invention. The present invention may comprise a triangular housing 10. The triangular shape allows the first rotor 12 and second rotor 14 to be placed at angle. This allows the rotor paths of the first rotor and the second rotor 14 to overlap. In another example embodiment of the present invention, the housing 10 may be another shape that has at least two angled sides. The housing would be configured such that the first rotor 12 and second rotor 14 are at an angle, such that the first rotor 12 and the second rotor 14 are have an overlapping path. This would promote a more compact and efficient design of a rotary aircraft.

The present invention may further comprise an assembly unit 20. The detachable assembly unit 20 is located below the housing 10. The assembly unit 20 is attached under the synchronizing mechanism and attaches to the original control and support head of the device. The assembly unit can be affixed to the rotary aircraft by methods known to people of ordinary skill in the art, such as welding, clamps, bolts or other attachment devices.

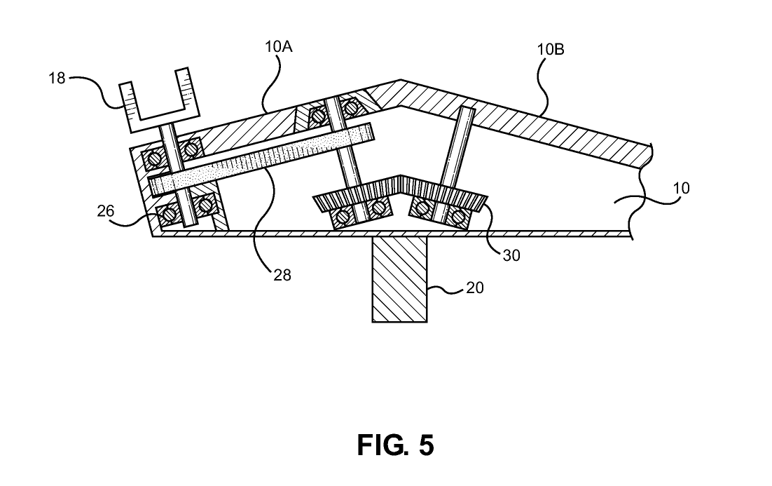

Referring now to FIG. 5, there is shown the gear mechanism in the housing 10 of the synchronization mechanism according to one embodiment of the present invention. The gear mechanism is located in the body of the housing 10. The gear mechanism includes bearings 26, a chain drive 28, and an angled worm gear 30. The gear mechanism secures and prevents slipping of the rotors along the chain drive 28, without having to provide their own braking devices by locking the teeter bolts 18. The rotors are preferably connected via a self-locking mechanical transmission, in particular a worm gear 30. The gear mechanism is non-slip mechanism similar to a gear system in a conventional watch. Corresponding gear mechanisms may be located on the first angled side of the housing 10A and the second angled side of the housing 10B.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An apparatus for synchronizing overlapping rotors in a rotary aircraft, comprising:
a housing having a substantially triangular top portion;
a first angled side of the housing;
a second angled side of the housing;
a first rotor attached to the first angled side of the housing having a first rotor path;
a second rotor attached to the second angled side of the housing having a second rotor path;
wherein a portion of the first rotor path and a portion of the second rotor path overlap.

2. The apparatus of claim 1, wherein the first rotor and the second rotor are attached to the housing by a teeter bolt.

3. The apparatus of claim 1, wherein the housing secures the first rotor and the second rotor such that the rotor path of the first rotor and the second rotor do not strike.

4. The apparatus of claim 1, wherein the housing is a triangular shape such that the first rotor and second rotor are at an angle.

5. The apparatus of claim 1, wherein the first rotor and the second rotor are configured to have an overlapping path.

6. The apparatus of claim 1, wherein the teeter bolt allows a pitch of the first rotor and the second rotor to be adjusted.

7. The apparatus of claim 1, further comprising an assembly unit below the housing.

8. The apparatus of claim 1, wherein the first rotor and the second rotor comprise a plurality of blades that are adapted to rotate about a central shaft.

9. The apparatus of claim 1, wherein the housing includes a gear assembly having a plurality of bearings, a chain drive, and an angled worm gear on the first angled side and the second angled side of the housing.
